(19) United States
(12) Patent Application Publication
(10) Pub. No.: US 2026/0003927 A1
(43) Pub. Date: Jan. 1, 2026

(54) ADD-IN RECOMMENDATION SYSTEM

(71) Applicant: Microsoft Technology Licensing, LLC, Redmond, WA (US)

(72) Inventors: Sayan CHALIHA, Marathahalli (IN); Meghna MANJAREE, Morabadi (IN); Rama Kant PATHAK, Bengaluru (IN); Padmanabhan SUNDARARAJAN, Bengaluru (IN); Rajiv SRIVASTAVA, Bengaluru (IN); Nikita MITTAL, Bengaluru (IN); Poonam SAVALE, Bangalore (IN); Snigdha VERMA, Bangalore (IN); Arul Prabhu R, Bangalore (IN); Teekam Chand GOYAL, Telangana (IN)

(73) Assignee: Microsoft Technology Licensing, LLC, Redmond, WA (US)

(21) Appl. No.: 18/759,067

(22) Filed: Jun. 28, 2024

(51) Int. Cl. G06F 16/958; G06F 16/955

(52) U.S. Cl. CPC G06F 16/958; G06F 16/9558

(57) ABSTRACT

An add-in recommendation system receives add-in recommendation requests from an add-in recommendation client which includes context information pertaining to user interactions with a client application. The context information is mapped to an embedding space using an encoder to generate a context embedding. An add-in recommendation engine compares the context embedding to an add-in index using to identify a predetermined number of add-in deep links to include in an add-in recommendation. The add-in index includes a plurality of add-in embeddings, each add-in embedding being associated with an add-in deep link which is accessible to the user and being used to map a semantic description of the add-in deep link to the embedding space. The add-in recommendation to the add-in recommendation client and displayed in a user interface of the client application.

### BACKGROUND

Many add-ins enable add-in functionality to be accessed using deep links. A deep link is a type of hyperlink that enables users to access a specific location, or target, within a web application directly by bypassing the homepage or main entry point of the web application. Deep links can enhance user experience by providing direct access to content that is relevant to a user's needs or interests.

However, finding and using the right deep links for a specific task or context can be challenging for users, especially when there are many add-ins available in an add-in store or installed by a user. In addition, users may not be aware of the existence or capabilities of some add-ins, or may not remember how to access or launch them. Moreover, some add-ins may be more relevant or useful than others depending on the current context, such as the type of document or email, the content of the document and a user's usage pattern.

Hence, what is needed is an improved add-in recommendation system for providing recommendations for add-in actions.

### SUMMARY

In one general aspect, the instant disclosure presents a data processing system having a processor and a memory in communication with the processor wherein the memory stores executable instructions that, when executed by the processor alone or in combination with other processors, cause the data processing system to perform multiple functions. The functions may include receiving an add-in recommendation request from an add-in recommendation client of an add-in recommendation system, the add-in recommendation client being associated with a client application at a client device, the add-in recommendation request including context information pertaining to user interactions with the client application; mapping the context information to an embedding space using an encoder of the add-in recommendation system to generate a context embedding; comparing the context embedding to an add-in index using an add-in recommendation engine of the add-in recommendation system to identify add-in deep links to include in an add-in recommendation, the add-in index including a plurality of add-in embeddings, each add-in embedding being associated with an add-in deep link which is accessible to the user and being used to map a semantic description of the add-in deep link to the embedding space; returning the add-in recommendation to the add-in recommendation client; and displaying the add-in deep links included in the add-in recommendation in a user interface of the client application. The functions further comprise: performing an add-in index generating process using an indexing component of the add-in recommendation system, the index generating process including: requesting add-in information from at least one add-in source which identifies add-in deep links which are accessible to the user, the add-in information including semantic descriptions of each of the add-in deep links which are accessible to the user; generating the add-in embeddings which map the semantic descriptions of the add-in deep links to the embedding space; and generating the add-in index using the add- in embeddings. The add-in recommendation engine comprises a generative artificial intelligence (AI) model trained to select the add-in deep links to recommend using a ranking function that ranks the add-in deep links based on distances between the context embedding and the add-in embeddings, the distances being indicative of similarities between the context information and the semantic descriptions of the add-in deep links.

In yet another general aspect, the instant disclosure presents a method for recommending add-in deep links using an add-in recommendation system. The method includes receiving an add-in recommendation request from an add-in recommendation client of the add-in recommendation system, the add-in recommendation client being associated with a client application at a client device, the add-in recommendation request including context information pertaining to user interactions with the client application; mapping the context information to an embedding space using an encoder of the add-in recommendation system to generate a context embedding; comparing the context embedding to an add-in index using an add-in recommendation engine of the add-in recommendation system to identify add-in deep links to include in an add-in recommendation, the add-in index including a plurality of add-in embeddings, each add-in embedding being associated with an add-in deep link which is accessible to the user and being used to map a semantic description of the add-in deep link to the embedding space; returning the add-in recommendation to the add-in recommendation client; displaying the add-in deep links included in the add-in recommendation in a user interface of the client application; and performing an add-in index generating process using an indexing component of the add-in recommendation system. The index generating process includes requesting add-in information from at least one add-in source which identifies add-in deep links which are accessible to the user, the add-in information including semantic descriptions of each of the add-in deep links which are accessible to the user; generating the add-in embeddings which map the semantic descriptions of the add-in deep links to the embedding space; and generating the add-in index using the add-in embeddings. The add-in recommendation engine comprises a generative artificial intelligence (AI) model trained to select the add-in deep links to recommend using a ranking function that ranks the add-in deep links based on distances between the context embedding and the add-in embeddings, the distances being indicative of similarities between the context information and the semantic descriptions of the add-in deep links.

In a further general aspect, the instant application describes a non-transitory computer readable medium on which are stored instructions that when executed cause a programmable device to perform functions of receiving an add-in recommendation request from an add-in recommendation client of an add-in recommendation system, the add-in recommendation client being associated with a client application at a client device, the add-in recommendation request including context information pertaining to user interactions with the client application; mapping the context information to an embedding space using an encoder of the add-in recommendation system to generate a context embedding; comparing the context embedding to an add-in index using an add-in recommendation engine of the add-in recommendation system to identify add-in deep links to include in an add-in recommendation, the add-in index including a plurality of add-in embeddings, each add-in embedding being associated with an add-in deep link which is accessible to the user and being used to map a semantic description of the add-in deep link to the embedding space; returning the add-in recommendation to the add-in recommendation client; and displaying the add-in deep links included in the add-in recommendation in a user interface of the client application; and performing an add-in index generating process using an indexing component of the add-in recommendation system. The index generating process includes requesting add-in information from at least one add-in source which identifies add-in deep links which are accessible to the user, the add-in information including semantic descriptions of each of the add-in deep links which are accessible to the user; generating the add-in embeddings which map the semantic descriptions of the add-in deep links to the embedding space; and generating the add-in index using the add-in embeddings. The add-in recommendation engine comprises a generative artificial intelligence (AI) model trained to select the add-in deep links to recommend using a ranking function that ranks the add-in deep links based on distances between the context embedding and the add-in embeddings, the distances being indicative of similarities between the context information and the semantic descriptions of the add-in deep links.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 is a diagram showing an example computing environment in which aspects of the disclosure are implemented.

FIG. 2 shows an example implementation of an add-recommendation system, which may be utilized by the add-recommendation service of FIG. 1.

FIG. 3 shows an example implementation of a user interface for the add-in recommendation system of FIG. 2.

FIG. 4 shows a flow diagram of an example process of generating and displaying recommendations by the add-in recommendation system of FIG. 2.

FIG. 5 is a flowchart of an example method for generating add-in deep link recommendations using the add-in recommendation system of FIG. 2.

FIG. 6 is a block diagram of an example computing device, which may be used to provide implementations of the mechanisms described herein; and

FIG. 7 is a block diagram illustrating components of an example machine configured to read instructions from a machine-readable medium.

### DETAILED DESCRIPTION

Many software applications, including content generating applications (e.g., word processors, spreadsheet programs, presentation applications), communication applications (e.g., email applications, messaging applications, chat applications, etc.), productivity applications (e.g., calendar applications, task list applications, etc.), and the like, allow users to extend the functionality of the application by installing add-ins. Add-ins are web applications that can run within a browser control or iFrame in the context of an application. Add-ins can interact with a host application's object model, user interface (UI), and settings, and provide additional features or services to the users. For example, an add-in can help users create tasks, schedule meetings, run checks, or insert content from external sources.

Many add-ins enable add-in actions and functionality to be accessed using deep links. A deep link is a type of hyperlink that enables users to access a specific location, or target, within a web application directly by bypassing the homepage or main entry point of the web application. Deep links can enhance user experience by providing direct access to content that is relevant to a user's needs or interests. As noted above, finding and using the right deep links for a specific task or context can be challenging for users, especially when there are many add-ins available in an add-in store or installed by a user. In addition, users may not be aware of the existence or capabilities of some add-ins, or may not remember how to access or launch them. Moreover, some add-ins may be more relevant or useful than others depending on the current context, such as the type of document or email, the content of the document and a user's usage pattern. Thus, there exists a technical problem of lack of mechanisms for efficiently enabling users to access and utilize application add-ins that are relevant to them.

To address the technical problems associated with identifying and recommending add-in actions for users to utilize in the user's current context, this description provides technical solutions in the form of an add-in recommendation system that can analyze the current user context to identify add-in actions to recommend which are relevant to the current user context and to provide deep links to the recommended add-in actions which can be embedded in the current user context, e.g., in a canvas of an application. By using the system to automatically identify add-in actions to recommend and provide deep-links to the recommended actions, the system can reduce the computing resources and network bandwidth that would otherwise be needed to manually search for add-in functionality and access multiple webpages to get to the page where task actions can be performed.

The add-in recommendation system includes an add-in indexing component that retrieves and indexes add-ins that are installed for a user or available to the user (e.g., via an organization or workplace). The indexing component generates an add-in index for a user that indexes semantic descriptions of deep links for each action present in the add-ins which are installed or accessible to a user. The add-in recommendation system also includes a recommendation engine that can generate recommendations of add-in deep links based on user contextual information, client capabilities, and usage data. The recommendation engine uses a similarity function or ranking function, such as cosine distance between context embeddings and add-in embeddings (e.g., semantic description embeddings) for the add-in deep links to identify the top k add-ins to recommend for a given user context. Usage data can be used to adjust engine performance to reflect user add-in preferences. Communication and interactions between a client application and the recommendation system are performed using a predefined Application Programming Interface (API) that provides an interface for the client application to get recommendations from the recommendation engine. The recommendation API receives input, such as user contextual information, and provides the context information to the recommendation engine. The recommendation API also returns add-in recommendations that are generated by the recommendation engine to the client application. Add-in recommendations may include a list of recommended add-in deep links with details, such as the application identifier, the action identifier, the label of the deep link, and the like.

The system utilizes an add-in recommendation client at the client device to extract contextual information from application content. In various implementations, the application content comprises responses from generative artificial intelligence (AI), such as Large Language Model (LLM). Generative AI responses are generated in response to a prompt or query and can include email summaries, conversation summaries, task information, calendar data, schedule information, and the like. The add-in recommendation client sends the context information to the recommendation system (via the recommendation API). The add-in recommendation client also detects the capabilities of the client device and the application, such as the form factor, version information, scope information, and the like. The add-in recommendation client then makes API call to the recommendation engine to get the recommended deep links and embed them in the canvas of the application. A recommendation UI component is used to display the recommendations to the user in a suitable format and location within the client application. The recommendation UI can also allow the user to interact with the recommendations, such as by clicking them. Usage data pertaining to user interactions with the embedded deep links is collected and used to adjust the performance/training of the recommendation engine to reflect user preferences.

The add-in recommendation client and/or a separate prompt generating component is used to generate a prompt for the recommendation engine that formats the context information in a manner that is understandable and facilitates processing by the recommendation engine. In various implementations, the recommendation engine comprises a generative artificial intelligence (AI) model, such as a Large Language Model (LLM), Generative Pre-trained Transformer (GPT)-based model (e.g., GPT-3, GPT-4, GPT-4o, ChatGPT), or the like.

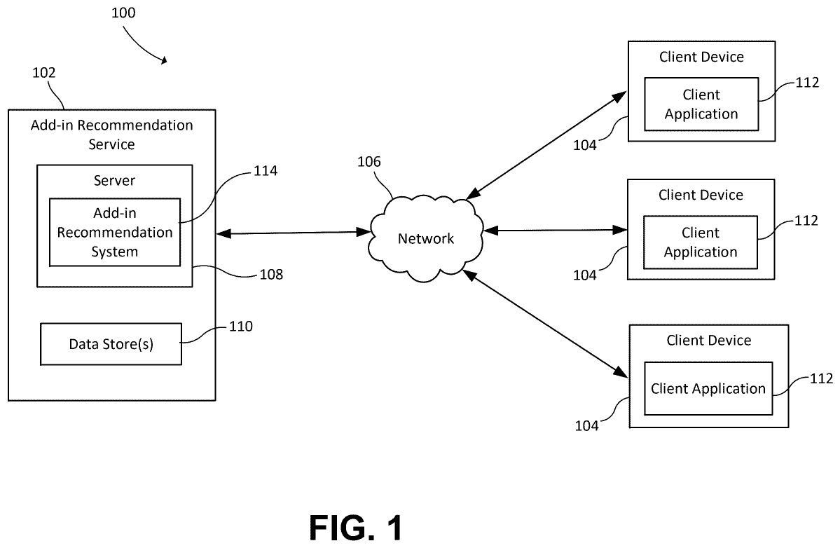

FIG. 1 shows an example computing environment 100 in which aspects of the disclosure may be implemented. The computing environment 100 includes an add-in recommendation service 102 and client devices 104 which communicate with each other via a network 106. The network 106 includes one or more wired, wireless, and/or a combination of wired and wireless networks. In some implementations, the network 106 includes one or more local area networks (LAN), wide area networks (WAN) (e.g., the Internet), public networks, private networks, virtual networks, mesh networks, peer-to-peer networks, and/or other interconnected data paths across which multiple devices may communicate. In some examples, the network 106 is coupled to or includes portions of a telecommunications network for sending data in a variety of different communication protocols. In some implementations, the network 106 includes Bluetooth® communication networks or a cellular communications network for sending and receiving data including via short messaging service (SMS), multimedia messaging service (MMS), hypertext transfer protocol (HTTP), direct data connection, WAP, email, and the like.

The add-in recommendation service 102 may be implemented as a cloud-based service or set of services. To this end, the add-in recommendation service 102 is executed on or includes at least one server 108 which is configured to provide computational and/or storage resources for implementing the add-in recommendation service 102. The server 108 is representative of any physical or virtual computing system, device, or collection thereof, such as, a web server, rack server, blade server, virtual machine server, or tower server, as well as any other type of computing system used to implement the add-in recommendation service 102. Servers are implemented using any suitable number and type of physical and/or virtual computing resources (e.g., standalone computing devices, blade servers, virtual machines, etc.). Add-in recommendation service 102 may also include one or more data stores 110 for storing data, programs, and the like for implementing and managing the add-in recommendation service 102. In FIG. 1, one server 108 and one data store 110 are shown, although any suitable number of servers and/or data stores may be utilized.

Client devices 104 enable users to access the add-in recommendation service 102 via the network 106. Client devices 104 can be any suitable type of computing device, such as personal computers, desktop computers, laptop computers, smart phones, tablets, gaming consoles, smart televisions and the like. Client devices 104 include at least one client application 112 that is configured to interact with and access the functionality provided by the add-in recommendation service 102. In various implementations, client application 112 is a dedicated application installed on the client device and programmed to interact with one or more services provided by cloud infrastructure. In some implementations, client application 112 is an add-on, extension, or the like that can be integrated into other applications to enable interaction with the add-in recommendation service 102. In some cases, client application 112 is a general-purpose application, such as a web browser, configured to access services and/or applications over the network 106.

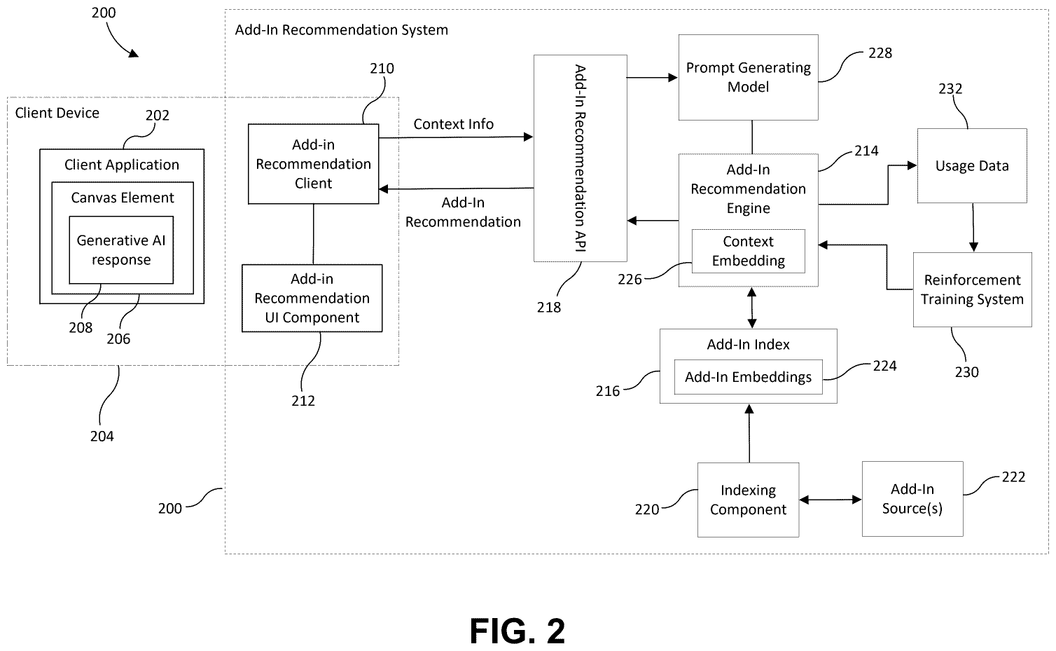

The add-in recommendation service 102 includes an add-in recommendation system 114 for implementing the add-in recommendation service 102. An example implementation of an add-in recommendation system 200 is shown in FIG. 2. Add-in recommendation system 200 interacts with a client application 202 which is associated with a client device 204. Client application 202 has canvas clement 206 for displaying a generative AI response 208. Generative AI responses 208 are generated in response to a prompt or query and can include various types of information and data, such as one or more documents, conversation summaries (i.e., emails, messages, etc.), task list(s), meeting information, project information, calendar/agenda summaries, productivity dashboards, and the like. Generative AI responses 208 can be generated by a generative AI model, such as a Large Language Model (LLM), Generative Pre-trained Transformer (GPT)-based model (e.g., GPT-3, GPT-4, GPT-4o, ChatGPT), or the like. For example, in various implementations, the generative AI response 208 can include an email summary generated by a personal assistant service, such as Copilot, that summaries emails received since the last time a user checked email. Generative AI responses 208 can also include schedule information, such as meetings, appointments, tasks, events, and the like which are scheduled to occur that day.

The add-in recommendation system 200 includes an add-in recommendation client 210, an add-in recommendation UI component 212, an add-in recommendation engine 214, an add-in index 216, and an add-in recommendation API 218. The add-in recommendation client 210 comprises an application, extension, add-in or the like which enables the client application 202 to interact with the add-in recommendation system 200. In various implementations, the add-in recommendation client 210 is configured to communicate context information to and receive add-in recommendations from the add-in recommendation system 200. The context information includes the generative AI response 208 as well as any other information which can be used by the system 200, such as document identifiers, client capabilities, form factor, version information, scope information, and the like. The add-in recommendation client 210 is configured to utilize a predefined add-in recommendation API 218 which defines how the add-in client can communicate with and access the functionality of the add-in recommendation system 200. The add-in recommendation client 210 receives add-in recommendations from the system 200 and causes the deep links included in the recommendation to be displayed in the add-in recommendation UI component 212. The add-in recommendation UI component 212 comprises a display clement, canvas clement, and/or the like via which deep link recommendations are displayed. The UI component 212 is also configured to allow interaction with the deep links, e.g., by clicking on a deep link and causing the deep link to be opened in the client application. In various implementations, the add-in recommendation UI component 212 is integrated into the main display region or canvas region of a client application so add- in recommendations can be displayed near the information with which they are associated.

The add-in recommendation engine 214 comprises one or more an artificial intelligence (AI) models and/or machine learning (ML) models trained to process user context information, including the generative AI response 208, to identify add-in deep links to recommend which are relevant to the user context. The add-in recommendation engine 214 uses the add-in index 216 to identify the add-in deep links to recommend. An add-in indexing component 220 generates the add-in index by communicating with one or more add-in sources 222 to retrieve a list of the add-ins included in the one or more add-in sources 222 and the deep links which are offered by each add-in. Add-in information can be retrieved from the add-in sources 222 in any suitable manner, such as by using predefined APIs for the add-in sources. The add-in information includes semantic descriptions of the add-ins and add-in deep links and other information, such as application identifiers, action identifiers, labels, tags, and the like. The indexing component 220 generates the add-in index 216 from the retrieved add-in information by mapping the add-in information to an embedding space to generate add-in embeddings 224. Add-in embeddings 224 may be generated using an encoder, such as a transformer-based encoder, or other suitable machine learning (ML) or artificial intelligence (AI) model/component. The embeddings 224 are generated in a manner that enables the similarities between context information and add-in information to be represented by distances between embeddings. The add-in embeddings 224 are then stored in a data structure, such as a vector database, which is accessible to the recommendation engine 214.

The add-in recommendation engine 214 is trained to process the user context information to generate a context embedding 226 which can then be compared to the add-in embeddings 224 in the add-in index to identify relevant add-in deep links to recommend. To this end, the recommendation engine 214 includes an encoder, such as a CLIP encoder, trained to map the context information to the same embedding space to which the add-in information is mapped. The relevant add-in deep links to recommend can be identified using the context embedding 226 and add-in embeddings 224 in any suitable manner. In various implementations, the recommendation engine 214 is trained to use cosine distance between context embeddings 226 and add-in embeddings 224 such that the add-in(s) embeddings 224 closest to the context embedding 226 are selected for a recommendation. In other implementations, any suitable method or algorithm may be used to select add-ins to recommend based on the context information. In operation, the recommendation engine 214 receives context information as input and outputs an add-in recommendation of one or more add-in deep links which are relevant to the context information. The add-in recommendation can include a list of recommended add-in deep links with details, such as the application ID, action ID, the label of the deep link, etc. The add-in recommendation is then returned to the add-in recommendation client 210 which causes the deep links to be displayed in the add-in recommendation UI component 212, e.g., as a hyperlink that can be selected (e.g., by clicking on with a mouse cursor) to cause a particular add-in page to be opened by the client application 202.

In various implementations, the add-in recommendation system 200 may include a prompt generating model 228 which is configured to format the context information in a manner that is understandable by the recommendation engine 214. For example, the prompt generating model may comprise an AI model which is trained to identify keywords, phrases, and the like in the context information which may correspond to add-in functionality, and to generate a suitable prompt for the recommendation engine 214 that identifies this information. The prompt generating model 228 may be trained to learn rules for determining user intent and/or context associated with a given term, or combination of terms. For example, the model 228 can be trained to recognize language indicating that a user is planning on having a meeting with a colleague or coworker. The model 228 can then generate a prompt indicating that a potential meeting is scheduled for a certain date and time. The recommendation engine 214 can process this information to retrieve a deep link to a meeting planning page for an online meeting application. In various implementations, the prompt generating model 228 comprises a generative language model, such as a Large Language Model (LLM), Generative Pre-trained Transformer (GPT)-based models (e.g., GPT-3, GPT-4, GPT-4o, ChatGPT), or the like.

The add-in recommendation system 200 also includes a reinforcement training system that is configured to provide user preference-based reinforcement training for the recommendation engine 214. To this end, the add-in recommendation system 200 is configured to collect usage data 232 pertaining to usage of the system 200 by users over time. The usage data 232 can be used to derive personal preference and feedback information which in turn can be used by the reinforcement training system 230 for ongoing training of the recommendation engine 214. The usage data includes user interaction data, user preference data, user feedback data, and the like which can be used to derive user preferences as to the add-ins and/or add-in functionality that are accessed to perform tasks in various contexts.

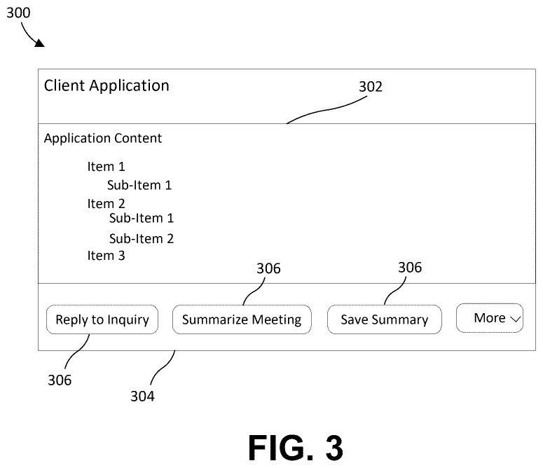

An example implementation of an add-in recommendation UI component is shown in FIG. 3. In FIG. 3, a client application UI includes a canvas area or display area 302 for displaying a generative AI response, such as an email summary, a document, task list, productivity dashboard, and the like. Add-in deep links 306 which are returned to the add-in recommendation client are then presented to the user in the add-in recommendation UI component 300, e.g., by embedding the links into a canvas area of an application. A user can access a deep link by clicking on one of the deep links which in turn causes a particular page of an add-in to be opened to perform an action, such as “reply to inquiry,” “summarize meeting,” and “save summary,” as shown in FIG. 3.

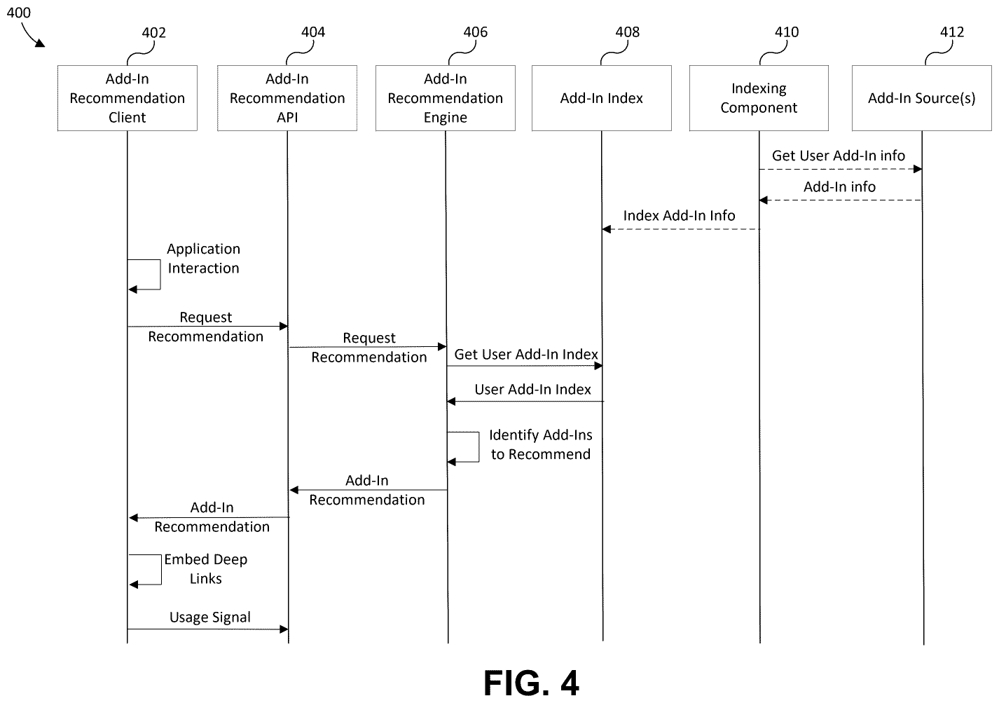

A flow diagram of an example method 400 for generating and displaying recommendations by an add-in recommendation system is shown in FIG. 4. At least some of the steps of method 400 are performed by an add-in recommendation system such as the an add-in recommendation system of FIG. 2. Method 400 begins and proceeds to generate an add-in index for a user. In particular, the indexing component 410 retrieves add-in information for a user from the add-in source(s) 412 and then generates an add-in index 408 for the user. During use, when an application is opened or interacted with at a client device, the add-in recommendation client 402 collects context information for the interaction which includes a generative AI response and other information, such as document identifiers, client capabilities, form factor, version information, scope information, and the like. The add-in client recommendation client 402 then requests an add-in recommendation from the add-in recommendation engine 406 via the add-in recommendation API 404. The recommendation request includes the context information. In response to receiving the request, the add-in recommendation engine 406 retrieves the user add-in index 408 and performs a matching and ranking process to generate an add-in recommendation that lists the top k add-ins or add-in deep links to recommend to the user. For example, the recommendation engine can be trained to use a cosine distance matching process on the context information (i.e., context embedding) and the add-in embeddings in the add-in index to select the top 3 add-ins or add-in deep links to recommend to the user. The add-in recommendation is returned to the add-in recommendation client 402 via the add-in recommendation API 404. The recommended add- in deep links are then displayed at the client device, e.g., by embedding the links in a canvas region of a client application or add-in recommendation UI. The add-in recommendation client 402 sends a usage signal indicative of user interactions with the deep links, e.g., indicating that a user has selected a deep link, dismissed a link, or the like. The usage data is collected by a reinforcement training system (not shown) which can use the usage data to perform ongoing user-preference-based reinforcement training of the recommendation engine.

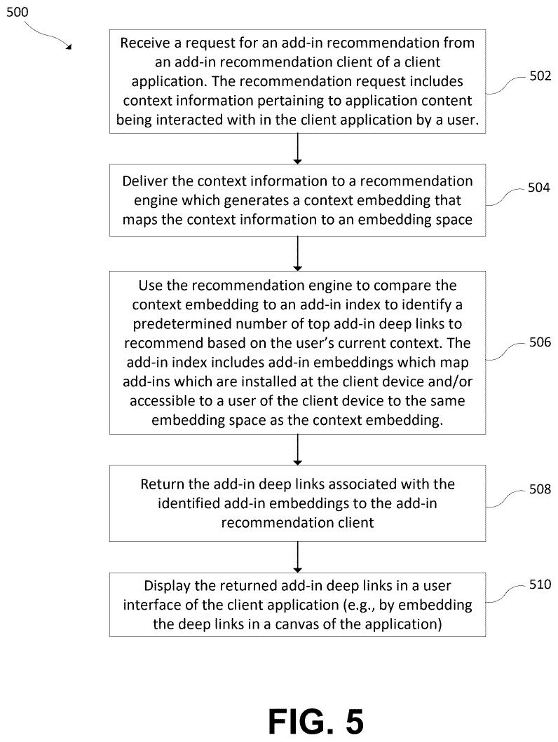

A flowchart of an example method 500 for providing add-in deep link recommendations using the add-in recommendation system described is shown in FIG. 5. The method 500 begins with receiving a request for an add-in recommendation from an add-in recommendation client for a client application, at 502. The request for an add-in recommendation includes context information pertaining to a generative AI response. The context information is provided to a recommendation engine which generates a context embedding which embeds the context information into an embedding space, at 504, and compares the context embedding to an add-in index to identify a predetermined number of top add-in deep links to recommend based on the user's current context, at 506. The add-in index includes add-in embeddings for add-ins which are installed at the client device and/or accessible to a user of the client device. The add-in embeddings map add-in information, including semantic descriptions of the add-ins and add-in deep links, to the same embedding space used for the context embedding. The recommendation engine compares the context embedding to the add-in embeddings using a similarity function or ranking function, such as a cosine distance function, to identify the top k add-in embeddings which are closest to the context embedding. The add-in deep links associated with the identified add-in embeddings are then returned to the add-in recommendation client, at 508, which presents the add-in recommendations to the user via the user interface of the client application, at 510, e.g., by embedding the deep links in a canvas of the client application.

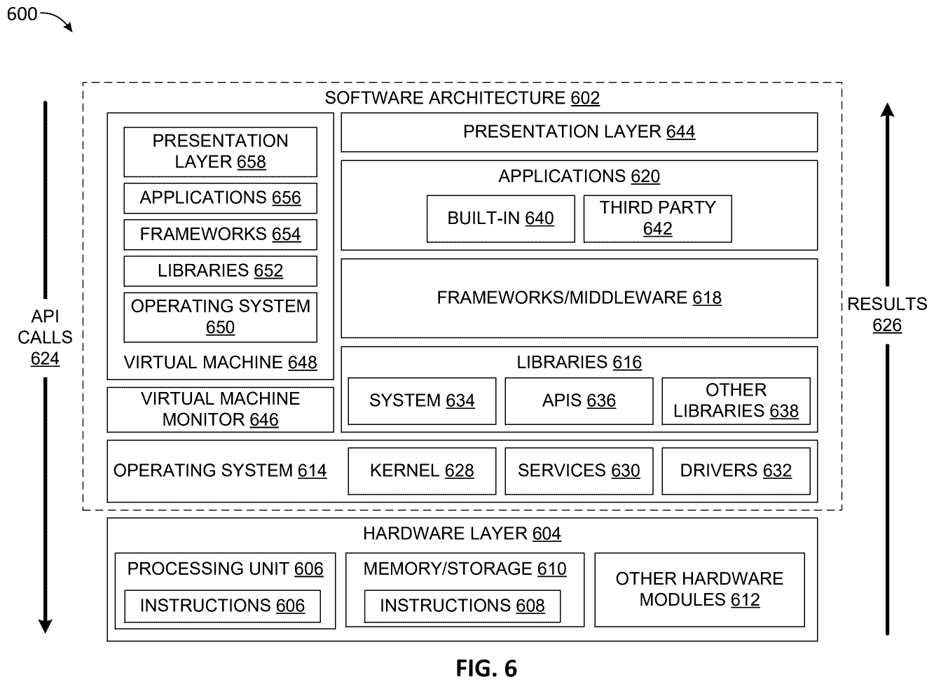

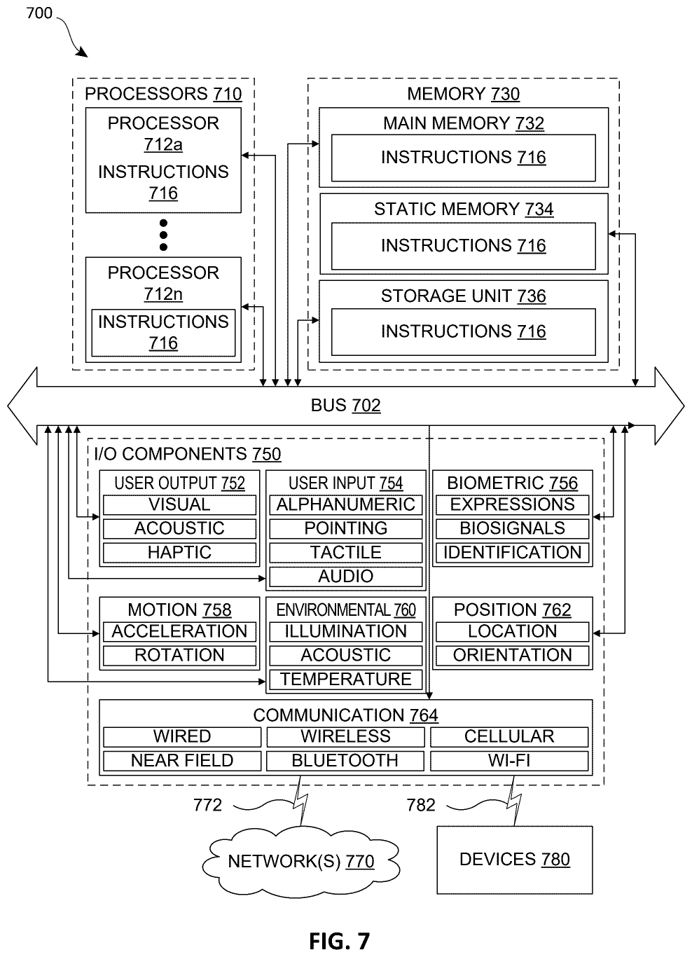

FIG. 6 is a block diagram 600 illustrating an example software architecture 602, various portions of which may be used in conjunction with various hardware architectures herein described, which may implement any of the above-described features. FIG. 6 is a non-limiting example of a software architecture, and it will be appreciated that many other architectures may be implemented to facilitate the functionality described herein. The software architecture 602 may execute on hardware such as a machine 700 of FIG. 7 that includes, among other things, processors 710, memory 730, and input/output (I/O) components 750. A representative hardware layer 604 is illustrated and can represent, for example, the machine 700 of FIG. 7. The representative hardware layer 604 includes a processing unit 606 and associated executable instructions 608. The executable instructions 608 represent executable instructions of the software architecture 602, including implementation of the methods, modules and so forth described herein. The hardware layer 604 also includes a memory/storage 610, which also includes the executable instructions 608 and accompanying data. The hardware layer 604 may also include other hardware modules 612. Instructions 608 held by processing unit 606 may be portions of instructions 608 held by the memory/storage 610.

The example software architecture 602 may be conceptualized as layers, each providing various functionality. For example, the software architecture 602 may include layers and components such as an operating system (OS) 614, libraries 616, frameworks/middleware 618, applications 620, and a presentation layer 644. Operationally, the applications 620 and/or other components within the layers may invoke API calls 624 to other layers and receive corresponding results 626. The layers illustrated are representative in nature and other software architectures may include additional or different layers. For example, some mobile or special purpose operating systems may not provide the frameworks/middleware 618.

The OS 614 may manage hardware resources and provide common services. The OS 614 may include, for example, a kernel 628, services 630, and drivers 632. The kernel 628 may act as an abstraction layer between the hardware layer 604 and other software layers. For example, the kernel 628 may be responsible for memory management, processor management (for example, scheduling), component management, networking, security settings, and so on. The services 630 may provide other common services for the other software layers. The drivers 632 may be responsible for controlling or interfacing with the underlying hardware layer 604. For instance, the drivers 632 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 616 may provide a common infrastructure that may be used by the applications 620 and/or other components and/or layers. The libraries 616 typically provide functionality for use by other software modules to perform tasks, rather than interacting directly with the OS 614. The libraries 616 may include system libraries 634 (for example, C standard library) that may provide functions such as memory allocation, string manipulation, file operations. In addition, the libraries 616 may include API libraries 636 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 616 may also include a wide variety of other libraries 638 to provide many functions for applications 620 and other software modules.

The frameworks 618 (also sometimes referred to as middleware) provide a higher-level common infrastructure that may be used by the applications 620 and/or other software modules. For example, the frameworks/middleware 618 may provide various graphic user interface (GUI) functions, high-level resource management, or high-level location services. The frameworks/middleware 618 may provide a broad spectrum of other APIs for applications 620 and/or other software modules.

The applications 620 include built-in applications 640 and/or third-party applications 642. Examples of built-in applications 640 may include, but are not limited to, a contacts application, a browser application, a location application, a media application, a messaging application, and/or a game application. Third-party applications 642 may include any applications developed by an entity other than the vendor of the particular platform. The applications 620 may use functions available via OS 614, libraries 616, frameworks/middleware 618, and presentation layer 644 to create user interfaces to interact with users.

Some software architectures use virtual machines, as illustrated by a virtual machine 648. The virtual machine 648 provides an execution environment where applications/modules can execute as if they were executing on a hardware machine (such as the machine 700 of FIG. 7, for example). The virtual machine 648 may be hosted by a host OS (for example, OS 614) or hypervisor, and may have a virtual machine monitor 646 which manages operation of the virtual machine 648 and interoperation with the host operating system. A software architecture, which may be different from software architecture 602 outside of the virtual machine, executes within the virtual machine 648 such as an OS 650, libraries 652, frameworks 654, applications 656, and/or a presentation layer 658.

FIG. 7 is a block diagram illustrating components of an example machine 700 configured to read instructions from a machine-readable medium (for example, a machine-readable storage medium) and perform any of the features described herein. The example machine 700 is in a form of a computer system, within which instructions 716 (for example, in the form of software components) for causing the machine 700 to perform any of the features described herein may be executed. As such, the instructions 716 may be used to implement modules or components described herein. The instructions 716 cause unprogrammed and/or unconfigured machine 700 to operate as a particular machine configured to carry out the described features. The machine 700 may be configured to operate as a standalone device or may be coupled (for example, networked) to other machines. In a networked deployment, the machine 700 may operate in the capacity of a server machine or a client machine in a server-client network environment, or as a node in a peer-to-peer or distributed network environment. Machine 700 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IOT) device. Further, although only a single machine 700 is illustrated, the term “machine” includes a collection of machines that individually or jointly execute the instructions 716.

The machine 700 may include processors 710, memory 730, and I/O components 750, which may be communicatively coupled via, for example, a bus 702. The bus 702 may include multiple buses coupling various elements of machine 700 via various bus technologies and protocols. In an example, the processors 710 (including, for example, a central processing unit (CPU), a graphics processing unit (GPU), a digital signal processor (DSP), an ASIC, or a suitable combination thereof) may include one or more processors 712a to 712n that may execute the instructions 716 and process data. In some examples, one or more processors 710 may execute instructions provided or identified by one or more other processors 710. The term “processor” includes a multicore processor including cores that may execute instructions contemporaneously. Although FIG. 7 shows multiple processors, the machine 700 may include a single processor with a single core, a single processor with multiple cores (for example, a multicore processor), multiple processors each with a single core, multiple processors each with multiple cores, or any combination thereof. In some examples, the machine 700 may include multiple processors distributed among multiple machines.

The memory/storage 730 may include a main memory 732, a static memory 734, or other memory, and a storage unit 736, both accessible to the processors 710 such as via the bus 702. The storage unit 736 and memory 732, 734 store instructions 716 embodying any one or more of the functions described herein. The memory/storage 730 may also store temporary, intermediate, and/or long-term data for processors 710. The instructions 716 may also reside, completely or partially, within the memory 732, 734, within the storage unit 736, within at least one of the processors 710 (for example, within a command buffer or cache memory), within memory at least one of I/O components 750, or any suitable combination thereof, during execution thereof. Accordingly, the memory 732, 734, the storage unit 736, memory in processors 710, and memory in I/O components 750 are examples of machine-readable media.

As used herein, “machine-readable medium” refers to a device able to temporarily or permanently store instructions and data that cause machine 700 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 716) for execution by a machine 700 such that the instructions, when executed by one or more processors 710 of the machine 700, cause the machine 700 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 750 may include a wide variety of hardware components adapted to receive input, provide output, produce output, transmit information, exchange information, capture measurements, and so on. The specific I/O components 750 included in a particular machine will depend on the type and/or function of the machine. For example, mobile devices such as mobile phones may include a touch input device, whereas a headless server or IoT device may not include such a touch input device. The particular examples of I/O components illustrated in FIG. 7 are in no way limiting, and other types of components may be included in machine 700. The grouping of I/O components 750 are merely for simplifying this discussion, and the grouping is in no way limiting. In various examples, the I/O components 750 may include user output components 752 and user input components 754. User output components 752 may include, for example, display components for displaying information (for example, a liquid crystal display (LCD) or a projector), acoustic components (for example, speakers), haptic components (for example, a vibratory motor or force-feedback device), and/or other signal generators. User input components 754 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 750 may include biometric components 756, motion components 758, environmental components 760, and/or position components 762, among a wide array of other physical sensor components. The biometric components 756 may include, for example, components to detect body expressions (for example, facial expressions, vocal expressions, hand or body gestures, or eye tracking), measure biosignals (for example, heart rate or brain waves), and identify a person (for example, via voice- , retina- , fingerprint- , and/or facial-based identification). The motion components 758 may include, for example, acceleration sensors (for example, an accelerometer) and rotation sensors (for example, a gyroscope). The environmental components 760 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 762 may include, for example, location sensors (for example, a Global Position System (GPS) receiver), altitude sensors (for example, an air pressure sensor from which altitude may be derived), and/or orientation sensors (for example, magnetometers).

The I/O components 750 may include communication components 764, implementing a wide variety of technologies operable to couple the machine 700 to network(s) 770 and/or device(s) 780 via respective communicative couplings 772 and 782. The communication components 764 may include one or more network interface components or other suitable devices to interface with the network(s) 770. The communication components 764 may include, for example, components adapted to provide wired communication, wireless communication, cellular communication, Near Field Communication (NFC), Bluetooth communication, Wi-Fi, and/or communication via other modalities. The device(s) 780 may include other machines or various peripheral devices (for example, coupled via USB).

In some examples, the communication components 764 may detect identifiers or include components adapted to detect identifiers. For example, the communication components 764 may include Radio Frequency Identification (RFID) tag readers, NFC detectors, optical sensors (for example, one-or multi-dimensional bar codes, or other optical codes), and/or acoustic detectors (for example, microphones to identify tagged audio signals). In some examples, location information may be determined based on information from the communication components 764, such as, but not limited to, geo-location via Internet Protocol (IP) address, location via Wi-Fi, cellular, NFC, Bluetooth, or other wireless station identification and/or signal triangulation.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element. Furthermore, subsequent limitations referring back to “said element” or “the element” performing certain functions signifies that “said element” or “the element” alone or in combination with additional identical elements in the process, method, article or apparatus are capable of performing all of the recited functions.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system for recommending application add-ins comprising:
a processor; and
a memory in communication with the processor, the memory comprising executable instructions that, when executed by the processor alone or in combination with other processors, cause the data processing system to perform functions of:
receiving an add-in recommendation request from an add-in recommendation client of an add-in recommendation system, the add-in recommendation client being associated with a client application at a client device, the add-in recommendation request including context information pertaining to user interactions with the client application;
mapping the context information to an embedding space using an encoder of the add-in recommendation system to generate a context embedding;
comparing the context embedding to an add-in index using an add-in recommendation engine of the add-in recommendation system to identify add-in deep links to include in an add-in recommendation, the add-in index including a plurality of add-in embeddings, each add-in embedding being associated with an add-in deep link which is accessible to the user and being used to map a semantic description of the add-in deep link to the embedding space;
returning the add-in recommendation to the add-in recommendation client; and
displaying the add-in deep links included in the add-in recommendation in a user interface of the client application,
wherein the functions further comprise:
performing an add-in index generating process using an indexing component of the add-in recommendation system, the index generating process including:
requesting add-in information from at least one add-in source which identifies add-in deep links which are accessible to the user, the add-in information including semantic descriptions of each of the add-in deep links which are accessible to the user;
generating the add-in embeddings which map the semantic descriptions of the add-in deep links to the embedding space; and
generating the add-in index using the add-in embeddings, and
wherein the add-in recommendation engine comprises a generative artificial intelligence (AI) model trained to select the add-in deep links to recommend using a ranking function that ranks the add-in deep links based on distances between the context embedding and the add-in embeddings, the distances being indicative of similarities between the context information and the semantic descriptions of the add-in deep links.

2. The data processing system of claim 1, wherein the add-in recommendation request and the add-in recommendation are communicated between the add-in recommendation client and the add-in recommendation system using an add-in recommendation Application Programming Interface (API).

3. The data processing system of claim 1 further comprising:
generating a prompt for the generative AI model that includes the context information.

4. The data processing system of claim 1, wherein the ranking function comprises a cosine distance function.

5. The data processing system of claim 1, wherein the context information includes a generative artificial intelligence (AI) response.

6. The data processing system of claim 5, wherein the generative AI response includes at least one of a document, an email, a conversation summary, and schedule information.

7. The data processing system of claim 1, wherein displaying the add-in deep links further comprises:
embedding the add-in deep links in a canvas of the user interface of the client application.

8. The data processing system of claim 1, further comprising:
opening a webpage associated with the add-in deep link in response to activation of the add-in deep link in the user interface of the client application.

9. A method for recommending add-in deep links using an add-in recommendation system, the method comprising:
receiving an add-in recommendation request from an add-in recommendation client of the add-in recommendation system, the add-in recommendation client being associated with a client application at a client device, the add-in recommendation request including context information pertaining to user interactions with the client application;
mapping the context information to an embedding space using an encoder of the add-in recommendation system to generate a context embedding;
comparing the context embedding to an add-in index using an add-in recommendation engine of the add-in recommendation system to identify add-in deep links to include in an add-in recommendation, the add-in index including a plurality of add-in embeddings, each add-in embedding being associated with an add-in deep link which is accessible to the user and being used to map a semantic description of the add-in deep link to the embedding space;
returning the add-in recommendation to the add-in recommendation client;
displaying the add-in deep links included in the add-in recommendation in a user interface of the client application; and
performing an add-in index generating process using an indexing component of the add-in recommendation system, the index generating process including:
requesting add-in information from at least one add-in source which identifies add-in deep links which are accessible to the user, the add-in information including semantic descriptions of each of the add-in deep links which are accessible to the user;
generating the add-in embeddings which map the semantic descriptions of the add-in deep links to the embedding space; and
generating the add-in index using the add-in embeddings,
wherein the add-in recommendation engine comprises a generative artificial intelligence (AI) model trained to select the add-in deep links to recommend using a ranking function that ranks the add-in deep links based on distances between the context embedding and the add-in embeddings, the distances being indicative of similarities between the context information and the semantic descriptions of the add-in deep links.

10. The method of claim 9, wherein the add-in recommendation request and the add-in recommendation are communicated between the add-in recommendation client and the add-in recommendation system using an add-in recommendation Application Programming Interface (API).

11. The method of claim 9, further comprising:
generating a prompt for the generative AI model that includes the context information.

12. The method of claim 9, wherein the ranking function comprises a cosine distance function.

13. The method of claim 9, wherein the context information includes a generative AI response.

14. The method of claim 13, wherein the generative AI response includes at least one of a document, an email, a conversation summary, and schedule information.

15. The data processing system of claim 1, wherein displaying the add-in deep links further comprises:
embedding the add-in deep links in a canvas of the user interface of the client application.

16. The method of claim 9, further comprising:
opening a webpage associated with the add-in deep link in response to activation of the add-in deep link in the user interface of the client application.

17. A non-transitory computer readable medium on which are stored instructions that, when executed, cause a programmable device to perform functions of:
receiving an add-in recommendation request from an add-in recommendation client of an add-in recommendation system, the add-in recommendation client being associated with a client application at a client device, the add-in recommendation request including context information pertaining to user interactions with the client application;
mapping the context information to an embedding space using an encoder of the add-in recommendation system to generate a context embedding;
comparing the context embedding to an add-in index using an add-in recommendation engine of the add-in recommendation system to identify add-in deep links to include in an add-in recommendation, the add-in index including a plurality of add-in embeddings, each add-in embedding being associated with an add-in deep link which is accessible to the user and being used to map a semantic description of the add-in deep link to the embedding space;
returning the add-in recommendation to the add-in recommendation client; and
displaying the add-in deep links included in the add-in recommendation in a user interface of the client application; and
performing an add-in index generating process using an indexing component of the add-in recommendation system, the index generating process including:
requesting add-in information from at least one add-in source which identifies add-in deep links which are accessible to the user, the add-in information including semantic descriptions of each of the add-in deep links which are accessible to the user;
generating the add-in embeddings which map the semantic descriptions of the add-in deep links to the embedding space; and
generating the add-in index using the add-in embeddings,
wherein the add-in recommendation engine comprises a generative artificial intelligence (AI) model trained to select the add-in deep links to recommend using a ranking function that ranks the add-in deep links based on distances between the context embedding and the add-in embeddings, the distances being indicative of similarities between the context information and the semantic descriptions of the add-in deep links.

18. The non-transitory computer readable medium of claim 17, wherein the context information includes a generative AI response.

19. The non-transitory computer readable medium of claim 17, wherein the generative AI response includes at least one of a document, an email, a conversation summary, and schedule information.

20. The non-transitory computer readable medium of claim 17, wherein:
the add-in recommendation engine comprises a generative artificial intelligence (AI) model trained to select the add-in deep links to recommend using a ranking function that ranks the add-in deep links based on cosine distances between the context embedding and the add-in embeddings, the distances being indicative of similarities between the context information and the semantic descriptions of the add-in deep links.
